(19) United States
(12) Patent Application Publication
(10) Pub. No.: US 2016/0148151 A1
(43) Pub. Date: May 26, 2016

(54) SERVER

(71) Applicant: TOSHIBA TEC KABUSHIKI KAISHA, Tokyo (JP)

(72) Inventor: Yukio Harada, Yokohama (JP)

(21) Appl. No.: 15/012,903

(22) Filed: Feb. 2, 2016

Related U.S. Application Data
(62) Division of application No. 14/709,615, filed on May 12, 2015.

(30) Foreign Application Priority Data
May 19, 2014 (JP) 2014-103724

(51) Int. Cl. G06Q 10/08; G06F 17/30

(52) U.S. Cl. CPC G06Q 10/087; G06F 17/3028

(57) ABSTRACT

A server stores a first image and a second image in association with an area ID and a store ID. The server, to a terminal, the first image and the second image which are associated with the area ID and the store ID.

### CROSS-REFERENCE TO RELATED APPLICATIONS

This application is a Division of application Ser. No. 14/709,615 filed on May 12, 2015; the entire contents of which are incorporated herein by reference.

This application is based upon and claims the benefit of priority from Japanese Patent Application No. 2014-103724, filed May 19, 2014, the entire contents of which are incorporated herein by reference.

### FIELD

Embodiments described herein relate to a server.

### BACKGROUND

In supermarkets or convenience stores, a portable ordering terminal is used as an ordering apparatus which supports merchandise ordering business. The ordering terminal correlates merchandise identifier and an ordered quantity of merchandise which are input via an input device with each other so as to create merchandise ordering data which is then transmitted to an external server via a communication unit.

In recent years, not only store ordering in which a store directly places an order with an ordering destination but also center ordering in which a head office collectively places an order corresponding to each store and then the ordering destination directly delivers merchandise to the store, have been performed. According to such center ordering, ordering is performed on the basis of merchandise sales data of each store.

However, in the above-described center ordering method, the head office cannot understand a situation of a sales floor of each store, and thus it cannot necessarily be said that a proper quantity is ordered in an ordering process based on merchandise sales data of each store.

JP-A-2013-8088 is an example of the related art.

### DESCRIPTION OF THE DRAWINGS

FIG. 1 is an entire configuration diagram illustrating a head office system using an ordering terminal according to an exemplary embodiment.

FIG. 2 is a schematic diagram illustrating a structure of merchandise data accumulated in a merchandise database.

FIG. 3 is a schematic diagram illustrating an example of sales floor image data stored in a sales floor image storage unit.

FIG. 4 is a block diagram illustrating a configuration of main portions of an ordering terminal.

FIG. 5 is a front view illustrating an example of an ordering screen.

FIG. 6 is a schematic diagram illustrating a main memory area formed in a RAM of the ordering terminal.

FIG. 7 is a system configuration diagram schematically illustrating an entire configuration of a store system.

FIG. 8 is a block diagram illustrating a functional configuration of the ordering terminal.

FIG. 9 is a flowchart illustrating a flow of a sales floor viewing process.

FIG. 10 is a front view illustrating an example of a pop-up screen.

### DETAILED DESCRIPTION

An object of exemplary embodiments is to provide an ordering apparatus, recording medium recording a merchandise ordering program and control method capable of checking the latest display situation of any store and any merchandise group and inputting a highly accurate order in a head office.

An server, to communicate via a network with a store system and a terminal, the store system comprising a camera to deliver an first image of a display area of merchandises in a store and a second image of the display area of the merchandises in the store after the first image, the store being associated with a store ID, the display area of the merchandises being associated with an area ID, the terminal for transmitting the store ID and the area ID, of an exemplary embodiment includes

a storage that stores the first image and the second image in association with the area ID and the store ID, and an interface which transmits, to the terminal, the first image and the second image which are associated with the area ID and the store ID.

Hereinafter, with reference to the drawings, a description will be made of an exemplary embodiment of an ordering apparatus which supports merchandise ordering businesses. In the present exemplary embodiment, a description will be made of an example of employing a center ordering method in which a head office collectively places an order corresponding to each store, and an ordering destination directly delivers merchandise to the store.

The present exemplary embodiment corresponds to a case where an ordering program for causing an information terminal (tablet terminal) which is a portable computer apparatus to function as an ordering apparatus is mounted therein, and the information terminal is applied as an ordering terminal. The ordering apparatus is not limited to an information terminal (tablet terminal) which is a portable computer apparatus and may be a general personal computer, a smartphone, or the like.

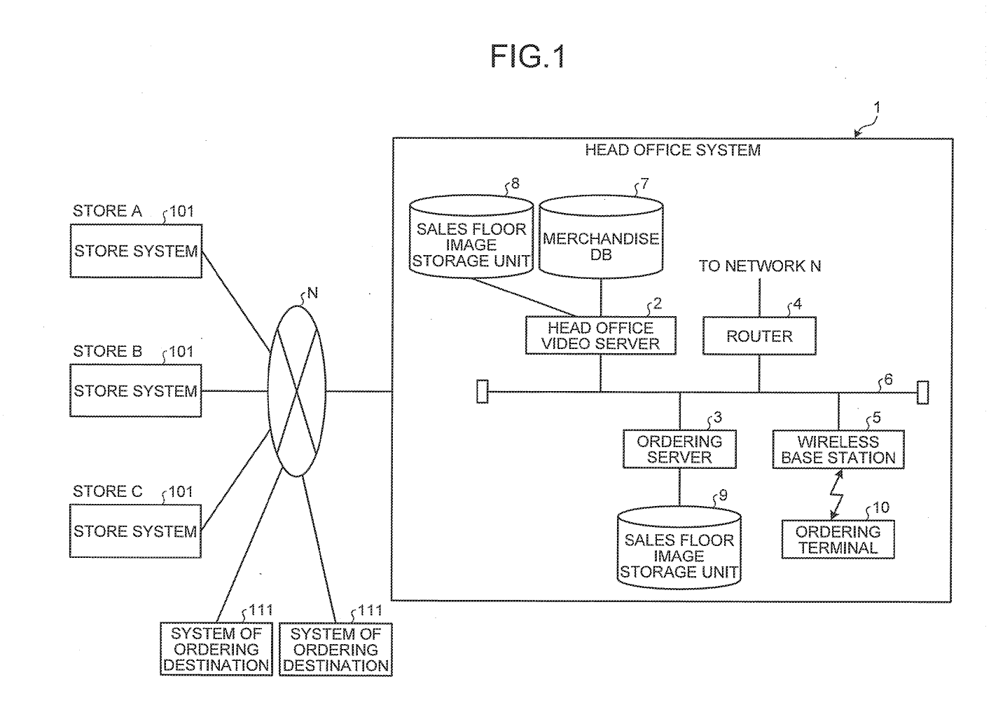

FIG. 1 is an entire configuration diagram illustrating a head office system 1 using an ordering terminal 10 according to an exemplary embodiment. As illustrated in FIG. 1, the head office system 1 can be connected to a store system 101 provided in each store or an ordering destination system 111 via a network N such as the Internet.

The head office system 1 includes not only the ordering terminal 10 but also a head office video server 2, an ordering server 3, a router 4, and a wireless base station 5. The head office video server 2, the ordering server 3, the router 4, and the wireless base station 5 are connected to each other via a local area network (LAN) 6.

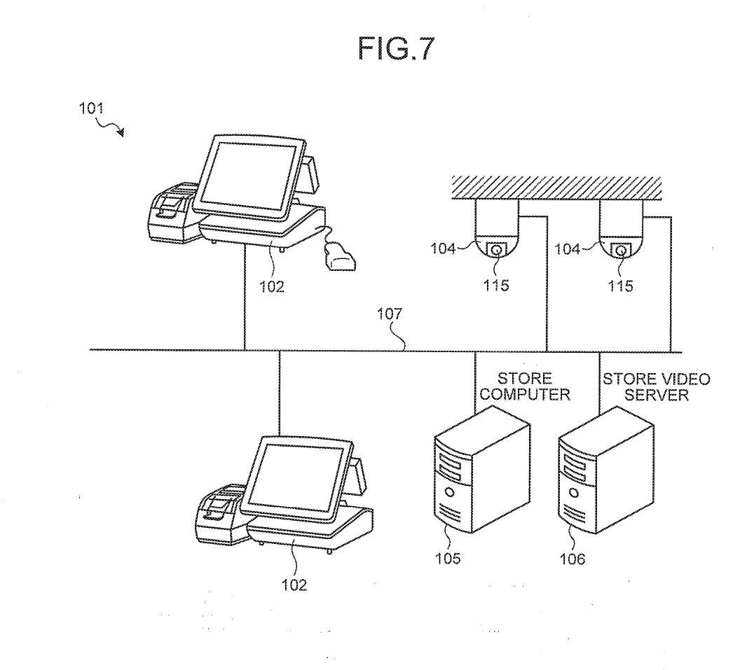

The router 4 connects the LAN 6 to the network N. The wireless base station 5 is wirelessly connected to the ordering terminal 10 which is a mobile station. At least a store computer 105 or a store video server 106 (refer to FIG. 7) of the store system 101 provided in each store is connected to the network N which is connected via the router 4.

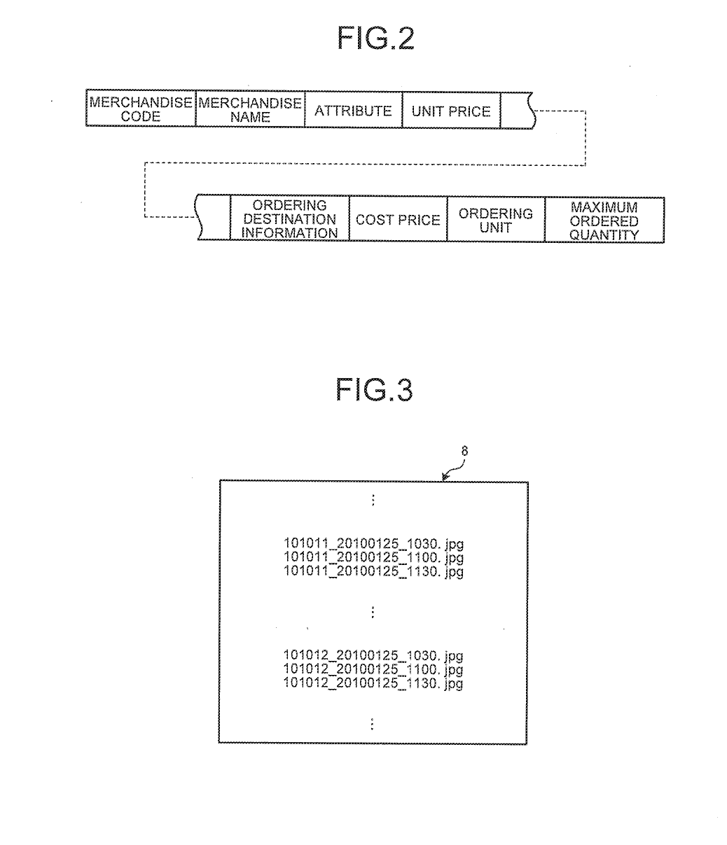

The head office video server 2 manages a merchandise database (DB) 7 which accumulates merchandise data. FIG. 2 is a schematic diagram illustrating a structure of merchandise data accumulated in the merchandise database 7. As illustrated in FIG. 2, the merchandise data includes at least items such as a merchandise code, a merchandise name, an attribute, a unit price, ordering destination information, a cost price, the ordering unit, and the maximum order quantity. The merchandise code functions as a merchandise identifier for specifying merchandise.

The ordering unit is a minimum number which is permitted in one order. For example, the ordering unit of merchandise for which an order can be placed with a dozen as the minimum unit is “12”, and the ordering unit of merchandise for which an order can be placed with a case containing ten pieces as the minimum unit is “10”. For example, an order for the former merchandise can be placed if an order quantity is integer multiples of “12”, such as “12”, “24”, “36”, . . . , otherwise, an order cannot be placed.

The maximum order quantity is a quantity which is permitted in one order. For example, if a dozen is the minimum unit, the maximum order quantity of merchandise for which an order can be placed up to ten dozens is “10”. Similarly, if a case containing ten pieces is the minimum unit, the maximum order quantity of merchandise for which an order can be placed up to twenty cases is “20”. Here, the ordering unit and the maximum order quantity serve as conditions for determining whether or not an order quantity is an appropriate value.

A point of sales (POS) terminal 102 (refer to FIG. 7) of the store system 101 provided in each store registers sales data of merchandise purchased by a customer on the basis of data managed by the merchandise database 7 of the head office video server 2. The merchandise sales data registered by each POS terminal 102 is transmitted to the store computer 105 provided in each store, and is totalized as the entire store sales information (store sales data) of the store.

The head office video server 2 receives and manages the store sales information (store sales data) totalized by the store computer 105 in the above-described way from the store system 101 of each store.

In addition, as will be described later in detail, the head office video server 2 stores an image of a sales floor in the store, captured by live cameras 104 (refer to FIG. 7) of the store system 101 provided in the store in a sales floor image storage unit 8 as sales floor image data for each sales floor of each store.

Next, a description will be made of sales floor image data stored in the sales floor image storage unit 8. FIG. 3 is a schematic diagram illustrating an example of the sales floor image data stored in the sales floor image storage unit 8. As illustrated in FIG. 3, the sales floor image data is configured to include a plurality of still image files with, for example, a Joint Photographic Experts Group (JPEG) format. A video of each sales floor is recorded in a time series as a still image file for each time zone in the sales floor image storage unit 8. Specifically, the leading two digits are codes indicating a store number, the next two digits are codes indicating a section number, and the next two digits are codes indicating a sales floor. In addition, the numerals following the first under bar indicate the imaging date, and the numerals following the second under bar indicate the imaging time. A still image of the sales floor is recorded with a file name formed by the numerals.

In a case of “101011_20100125_1030.jpg” in the example illustrated in FIG. 3, the leading two digits “10” indicate a store number, the next two digits “10” indicate a section number, the next two digits “11” indicate a sales floor related to side dishes, “20100125” indicates that the image was captured on Jan. 25, 2010, and “1030” indicates that the image was captured at 10:30.

The head office video server 2 acquires the sales floor image data transmitted from the live cameras 104 provided at each sales floor at predetermined time intervals (for example, every one minute, or every five minutes) from the store system 101, and adds the above-described file name thereto and records the sales floor image data. Therefore, a video of each sales floor for each time zone can be acquired by referring to the file name of the data file which is recorded as the sales floor image data.

The present exemplary embodiment exemplifies a configuration in which a video of each sales floor for each time zone is recorded as a still image file. However, in relation to time-series recording of a video of each sales floor, the video may be sequentially recorded as moving image data with, for example, a Moving Picture Experts Group (MPEG) format. Even if a video of each sales floor is sequentially recorded as moving image data, a still image can be acquired for each time zone by designating a frame position. As described above, time-series recording of videos of each sales floor is assumed to include recording of continuous moving images and recording of still images which are intermittently captured at predetermined time intervals.

The ordering server 3 receives ordering data corresponding to each store from the ordering terminal 10, and places an order corresponding to each store with a system 111 of an ordering destination via the network N on the basis of the data managed by the merchandise database 7 of the head office video server 2.

The ordering server 3 receives the sales floor image data stored in the sales floor image storage unit 8 managed by the head office video server 2 from the head office video server 2 at predetermined time intervals (for example, every one minute or every five minutes), and stores the data in a sales floor image storage unit 9 with the same file name as the image file name of the sales floor image data stored in the sales floor image storage unit 8. Consequently, the ordering server 3 stores the latest image file at all times.

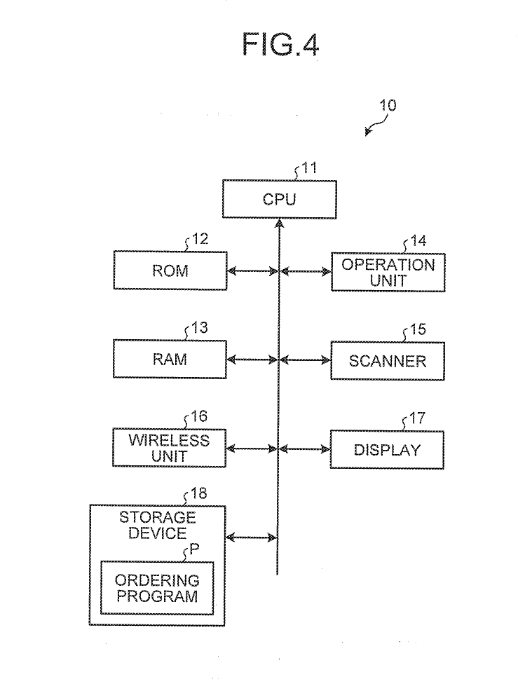

Next, a description will be made of the ordering terminal 10 which is an ordering apparatus supporting merchandise ordering business. FIG. 4 is a block diagram illustrating a configuration of main portions of the ordering terminal 10. As illustrated in FIG. 4, the ordering terminal 10 includes a central processing unit (CPU) 11 forming a computer main body, a read only memory (ROM) 12 and a random access memory (RAM) 13 forming a main storage unit, an operation unit 14 which is a first input device, a scanner 15 which is a second input device, a wireless unit 16 which is a communication unit, a display 17 which is a display device, and a storage device 18 such as a solid state drive (SSD).

The operation unit 14 is constituted by a touch panel or a keyboard, and includes a ten-key pad for inputting an order quantity of merchandise, and various function keys.

The scanner 15 reads a merchandise code from an information medium (for example, a barcode or an RFID tag) attached to each piece of merchandise. The wireless unit 16 performs wireless communication with the wireless base station 5. The display 17 displays a merchandise name of merchandise specified by the merchandise code read by the scanner 15, an order quantity of merchandise, or the like.

The storage device 18 stores an ordering program P for realizing an ordering function of collectively placing an order corresponding to each store in the head office, or a sales floor viewing function.

The ordering program P executed by the ordering terminal 10 of the present exemplary embodiment is recorded on a computer readable recording medium such as a CD-ROM, a flexible disk (FD), a CDR, or a digital versatile disk (DVD) in a file with an installable format or an executable format, and is provided.

The ordering program P executed by the ordering terminal 10 of the present exemplary embodiment may be stored on a computer connected to a network such as the Internet and may be downloaded via the network so as to be provided. The ordering program P executed by the ordering terminal 10 of the present exemplary embodiment may be provided or distributed via a network such as the Internet.

The ordering program P of the present embodiment may be incorporated into a ROM or the like in advance and may be provided.

Next, a description will be made of functions which the ordering program P stored in the storage device 18 causes the CPU 11 of the ordering terminal 10 to realize.

First, among the functions which the ordering program P stored in the storage device 18 causes the CPU 11 of the ordering terminal 10 to realize, an ordering function performed in the related art will be described briefly. The CPU 11 of the ordering terminal 10 displays an ordering screen and receives input of a merchandise identifier for specifying ordered merchandise and an order quantity via the operation unit 14 or the scanner 15 in a typical ordering mode.

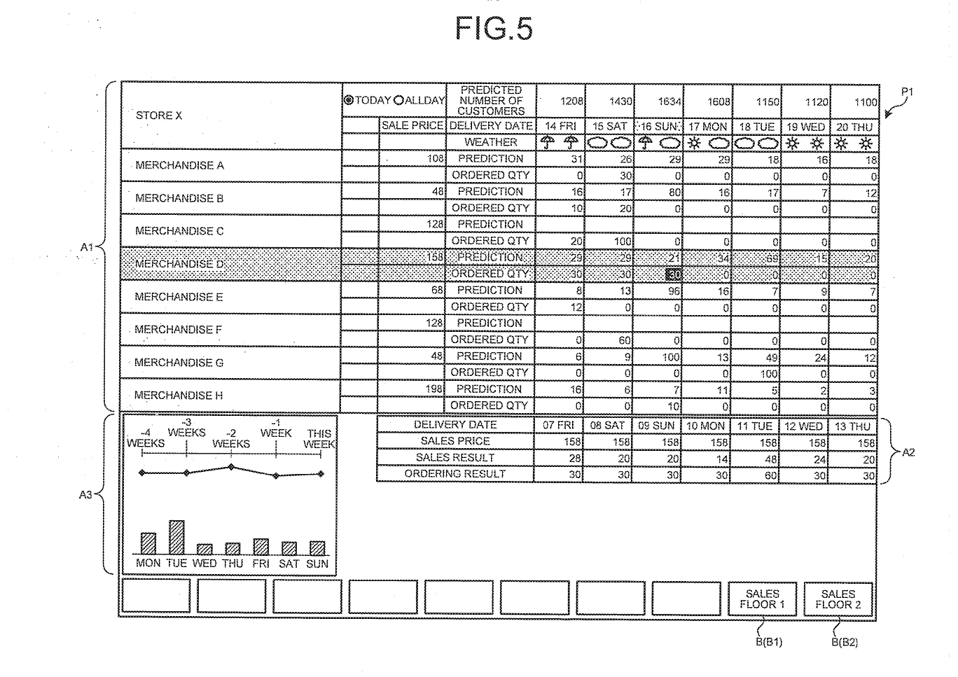

Here, FIG. 5 is a front view illustrating an example of an ordering screen P1. As illustrated in FIG. 5, the ordering screen P1 includes an order quantity input area A1 which allows an order quantity based on the delivery schedule date to be input in relation to merchandise which is an ordering target. A sales price of a single merchandise item, the weather of each delivery schedule date, a prediction of the number of merchandise items to be sold based on a predicted number of customers depending on a single merchandise item and day of the week, and the like are displayed in the order quantity input area A1.

In addition, the ordering screen P1 includes, as illustrated in FIG. 5, a past result display area A2 in which a past result of merchandise which is an ordering target selected in the order quantity input area A1 is displayed. In the past result display area A2, results (a sales price, the number of sold merchandise items, an order quantity, and the like) of the last week of the selected merchandise are displayed. In the example illustrated in FIG. 5, past results of selected “merchandise D” are displayed.

As illustrated in FIG. 5, the ordering screen P1 further includes a graph display area A3 in which the number of merchandise items sold in the past as an ordering target selected in the order quantity input area A1 is displayed in a graph form. In the graph display area A3, a total number of sold merchandise items for each week is displayed in a line graph form, and a totalized value for sales results for four weeks is displayed in a bar graph form. In the example illustrated in FIG. 5, the number of “merchandise items D” which are currently being selected and were sold in the past is displayed in a graph form.

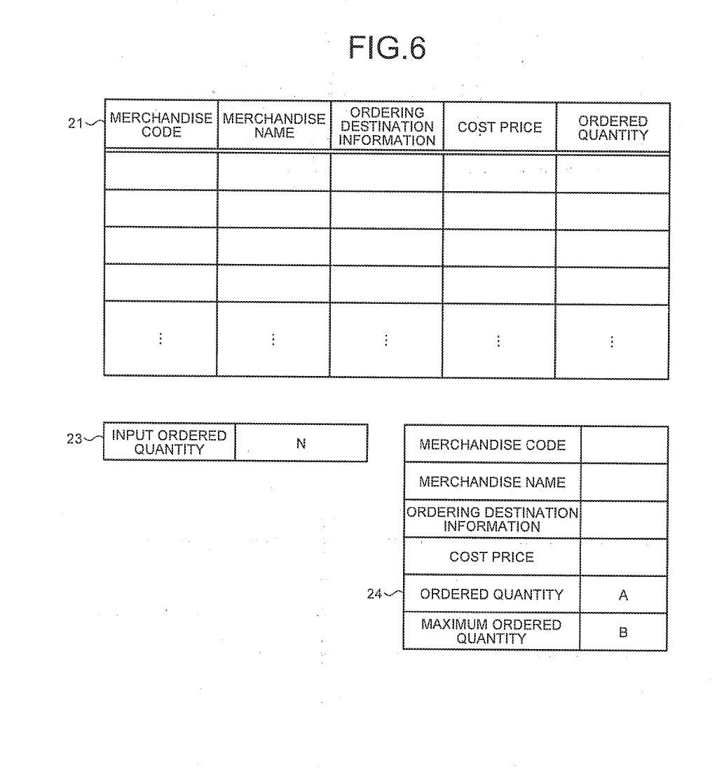

Whenever an order quantity is input to the order quantity input area Al on the ordering screen P1, the CPU 11 of the ordering terminal 10 creates merchandise ordering data in which a merchandise code (identification number) corresponding to the merchandise is correlated with the order quantity, and transmits the merchandise ordering data via the wireless unit 16 so as to place an order. Here, FIG. 6 is a schematic diagram illustrating main memory areas formed in the RAM 13 of the ordering terminal 10. As illustrated in FIG. 6, the ordering terminal 10 with this configuration forms, in the RAM 13, a buffer region (hereinafter, referred to as an ordering buffer) 21 which temporarily accumulates merchandise ordering data including at least a merchandise code, a merchandise name, ordering destination information, a cost price, and an order quantity; a memory region (an order quantity storage portion; hereinafter, referred to as an order quantity memory) 23 of an input order quantity N; and a memory region (hereinafter, referred to as an ordered merchandise memory) 24 of merchandise data including at least a merchandise code, a merchandise name, ordering destination information, a cost price, the ordering unit A, and the maximum order quantity B.

Meanwhile, if the center ordering method is employed as in the present exemplary embodiment, the head office cannot understand a situation of the sales floor of each store, and thus it cannot necessarily be said that a proper quantity is ordered in ordering based on merchandise sales data of each store.

Therefore, in the present embodiment, the ordering program P stored in the storage device 18 causes the CPU 11 of the ordering terminal 10 to execute a sales floor viewing function. Briefly, the sales floor viewing function is a function of displaying a situation of the sales floor of each store on the ordering screen P1 in order to understand the situation of the sales floor of each store when the head office performs an ordering process as described above.

As illustrated in FIG. 5, a sales floor viewing button B for declaring execution of the sales floor viewing function is displayed on the ordering screen P1. The sales floor viewing button B is displayed alone or in a plurality depending on a sales floor of merchandise which is an ordering target displayed on the ordering screen P1. In the example illustrated in FIG. 5, a sales floor viewing button B1 corresponding to a sales floor 1 on which any one of merchandise items A to H in a store X which are ordering targets displayed on the ordering screen P1 is displayed, and a sales floor viewing button B2 corresponding to a sales floor 2, are displayed.

First, a brief description will be made of a structure of collecting a situation of the sales floor of each store prior to a description of the sales floor viewing function of the ordering terminal 10.

FIG. 7 is a system configuration diagram schematically illustrating the entire configuration of the store system 101 provided in a store. The store system 101 illustrated in FIG. 7 includes the point of sales (POS) terminal 102 which performs accounting of sales merchandise or a sales registration process including registration of the sales merchandise, the live cameras 104 which image a space of the sales floor (not illustrated), and the store computer 105 or the store video server 106 as a server which is provided in a back office of the store and controls the entire store system 101. Each of the live cameras 104 is a PTZ camera which has a PTZ control function so that three remote operations including panning, tilting, and zooming can be performed. In the store system 101, the POS terminal 102, the live cameras 104, the store computer 105, the store video server 106 are communicably connected to each other via a communication network 107 such as a local area network (LAN). The store computer 105 or the store video server 106 can be connected to the head office system 1 via the network N such as the Internet.

As illustrated in FIG. 7, the live camera 104 is an imaging apparatus which forms an image which is incorporated from a lens 115 on, for example, a two-dimensional CCD array (not illustrated), and performs amplification, AID conversion, filtering, and the like on an output signal from the CCD array, so as to output the signal as a moving image or a still image. The live camera 104 is provided on each sales floor of a store, and delivers a video of a display shelf or the like as a moving image or a still image in detail. For example, the live camera 104 delivers a still image for each time zone. A network address (for example, an IP address or a MAC address) which is unique on a LAN is set in the live camera 104 provided on each sales floor. Therefore, the POS terminal 102 or the store video server 106 can acquire a video (a moving image or a still image) delivered from the live camera 104 of a predetermined sales floor by designating a network address.

The store video server 106 manages various information pieces transmitted from the POS terminal 102 or manages a moving image or a still image of each sales floor delivered from the live camera 104. For example, the store video server 106 manages a time zone and a sales floor-based still image delivered from the live camera 104 for each store. The store video server 106 transmits a moving image or a still image which is delivered from the live camera 104 for each sales floor, to the head office video server 2 of the head office system 1 at predetermined timing. In the present exemplary embodiment, a moving image or a still image of each sales floor delivered from the live camera 104 is managed by the store video server 106, but the present exemplary embodiment is not limited thereto. For example, the store computer 105 may manage a moving image or a still image.

With this configuration, image files (moving image or still image files) of each store and each sales floor captured by the live camera 104 of the store system 101 can be collected for each store by the head office video server 2 of the head office system 1. If journal data output from the store computer 105 of the store is transmitted to the head office video server 2 via the store video server 106, single merchandise item-based sales data and a video (a moving image or a still image) can be viewed in a unified manner.

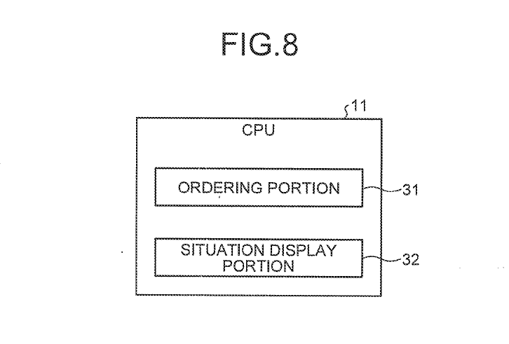

FIG. 8 is a block diagram illustrating a functional configuration of the ordering terminal 10. As illustrated in FIG. 8, the ordering program P stored in the storage device 18, executed by the CPU 11 of the ordering terminal 10 is modularly configured to include an ordering portion 31 and a situation display portion 32. In actual hardware, the CPU 11 of the ordering terminal 10 reads the ordering program P from the storage device 18 and executes the ordering program P, and thus the respective portions are loaded to the RAM 13 so that the ordering portion 31 and the situation display portion 32 are generated on the RAM 13.

The ordering portion 31 transmits merchandise ordering data in which an identification number corresponding to the merchandise is correlated with an order quantity of the merchandise, to the system 111 of the ordering destination, which is an external apparatus, the order quantity of the merchandise being input via the ordering screen P1 associated with a certain store.

The situation display portion 32 displays sales situation data according to a sales situation of merchandise at the present time or dating back from the present time in a certain store which is an input target of an order quantity when the order quantity is input via the ordering screen P1 of the ordering portion 31. The situation display portion 32 uses sales floor image data obtained by imaging a display position of the merchandise which is an input target of the order quantity with the live camera 104 which is an imaging apparatus at predetermined time intervals, as sales situation data.

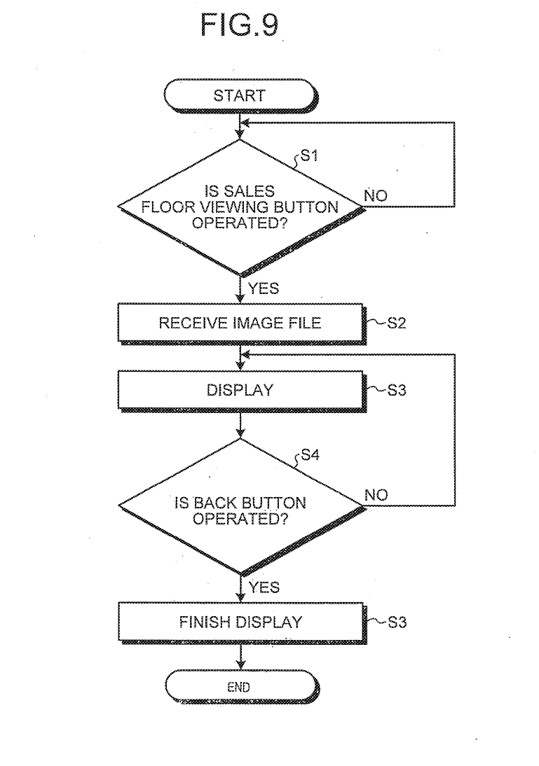

Next, a description will be made of a sales floor viewing process performed by the ordering terminal 10 which collectively places an order corresponding to each store in the head office. Here, FIG. 9 is a flowchart illustrating a flow of the sales floor viewing process.

As illustrated in FIG. 9, if the sales floor viewing button B (the sales floor viewing button B1 or the sales floor viewing button B2 in the example illustrated in FIG. 5) of the ordering screen P1 of a predetermined store which is an ordering target is operated (Yes in Act 1), the CPU 11 (the ordering portion 31) of the ordering terminal 10 receives image files (still images for each time zone) at a time point dating back to a predetermined time from the latest image file among image files (still images for each time zone) regarding a sales floor of the predetermined store corresponding to the operated sales floor viewing button B (the sales floor viewing button B1 or the sales floor viewing button B2 in the example illustrated in FIG. 5) from the ordering server 3 (Act 2)

Next, the CPU 11 (the situation display portion 32) of the ordering terminal 10 displays a list of thumbnail images of the plurality of received image files in a pop-up form on the ordering screen P1 (Act 3).

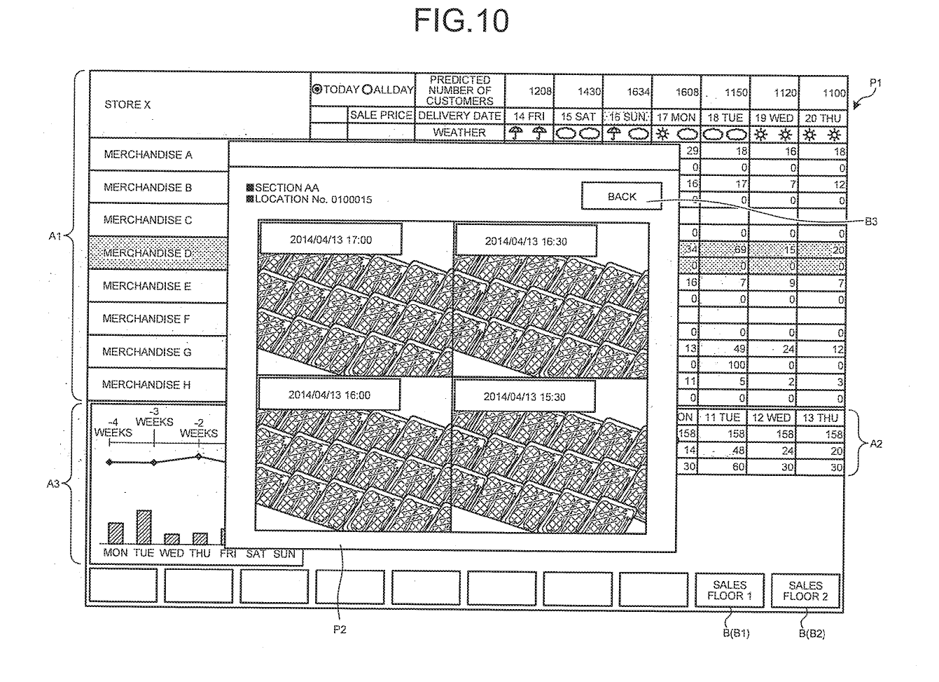

FIG. 10 is a front view illustrating an example of a pop-up screen P2 including the list of the thumbnail images. As illustrated in FIG. 10, the pop-up screen P2 which includes the list of the thumbnail images and is different from the ordering screen P1 is displayed on the ordering screen P1 in an overlapping manner. In the example of the pop-up screen P2 illustrated in FIG. 10, 2×2 thumbnail images of image files from the latest image file of sales floor display obtained by imaging the sales floor corresponding to the sales floor viewing button B (the sales floor viewing button B1 or the sales floor viewing button B2 in the example illustrated in FIG. 5) operated on the ordering screen P1 to an image file of sales floor display at a time point dating back a predetermined time are disposed side by side in a time series (on an hourly basis). Each thumbnail image represents a video of the sales floor every thirty minutes. Therefore, a user can check a state of a display shelf or the like on the sales floor every thirty minutes from the videos from “2014/04/13 17:00” to “2014/04/13 15:30”. The illustrated display aspect is only an example, and the number or an arrangement direction of displayed thumbnail images, a reference position at which thumbnail images of the sales floor related to the set search time are displayed, or the like may be changed as appropriate. In addition, an image may be displayed in real time.

Referring to the flowchart of FIG. 9 again, if a back button B3 displayed on the pop-up screen P2 is operated (Yes in Act 4), the CPU 11 (the situation display portion 32) of the ordering terminal 10 finishes the display of the pop-up screen P2 on the ordering screen P1 (Act 5).

As mentioned above, according to the present exemplary embodiment, when an order quantity is input via the ordering screen P1 associated with a certain store, sales situation data according to a sales situation of merchandise at the present time or dating back from the present time in the certain store which is an input target of the order quantity is displayed on the pop-up screen P2. Therefore, since the latest display situation of any store and any merchandise group can be checked, and a highly accurate order can be input, an appropriate order quantity can be input on the basis of a situation of a sales floor in the present state.

In the present exemplary embodiment, sales floor image data delivered from the live camera 104 provided in each sales floor of a store is applied as “sales data of the sales floor”, but the present exemplary embodiment is not limited thereto. For example, store sales information (store sales data) based on a sales registration process performed by the POS terminal 102 is collected from the store computer 105 of the store system 101 provided in each store by the ordering server 3 at predetermined time intervals. In addition, the ordering server 3 totalizes sales information (sales data) for each time zone regarding a sales floor corresponding to the sales floor viewing button B (the sales floor viewing button B1 or the sales floor viewing button B2 in the example illustrated in FIG. 5) operated on the ordering screen P1, and sets the totalized sales information as the “sales data of the sales floor”. Specifically, the ordering server 3 extracts sales data regarding merchandise displayed on a sales floor selected on the basis of a merchandise sorting code included in store sales information (store sales data) which is acquired from the store computer 105 at predetermined time intervals, totalizes sales of the displayed merchandise for each time zone on the basis of a data item regarding the date and time of the extracted sales data, and sets the totalized sales as the “sales data of the sales floor”.

The above-described totalized sales information of the displayed merchandise for each time zone is displayed on the pop-up screen P2 in a graph form (for example, a bar graph) indicating an amount of sales for each time zone. In addition, the sales information of the displayed merchandise for each time zone, displayed on the pop-up screen P2 includes sales information from the latest sales information to sales information at a time point dating back to a predetermined time.

Consequently, sales information regarding merchandise displayed on a sales floor corresponding to the sales floor viewing button B (the sales floor viewing button B1 or the sales floor viewing button B2 in the example illustrated in FIG. 5) operated on the ordering screen P1 can be easily checked among sales information pieces for each time zone.

The exemplary embodiment of the invention has been described, but the exemplary embodiment is only an example and is not intended to limit the scope of the invention. This novel exemplary embodiment may be implemented in other various embodiments, and may be implemented through various omissions, replacements, and modifications within the scope without departing from the spirit of the invention. The embodiments or the modifications thereof fall within the scope or the spirit of the invention and also fall within the inventions disclosed in the claims and the equivalents thereof.

What is claimed is:

1. A server,
to communicate via a network with a store system and a terminal,
the store system comprising a camera to deliver a first image of a display area of merchandises in a store and a second image of the display area of the merchandises in the store after the first image,
the store being associated with a store ID,
the display area of the merchandises being associated with an area ID,
the terminal for transmitting the store ID and the area ID, comprising:
a storage that stores the first image and the second image in association with the area ID and the store ID, and
an interface which transmits, to the terminal, the first image and the second image which are associated with the area ID and the store ID.

2. The server according to claim 1, wherein the storage stores a plurality of images including the first image and the second image in time series.

3. The server according to claim 1, wherein the storage stores four images including the first image and the second image, the four images representing the display area at predetermined time intervals.

4. The server according to claim 1, wherein the first image and the second image are still image.

5. The server according to claim 1, wherein the first image and the second image are movie.

6. The server according to claim 1, wherein the interface is a wireless base station.

7. The server according to claim 1, further comprising an order interface to receive an order quantity of the merchandises.
